(19) United States
(12) Patent Application Publication
(10) Pub. No.: US 2015/0214995 A1
(43) Pub. Date: Jul. 30, 2015

(54) SEMICONDUCTOR DEVICE, AND TRANSMISSION AND RECEPTION CIRCUIT

(71) Applicant: KABUSHIKI KAISHA TOSHIBA, Tokyo (JP)

(72) Inventor: Tadashi KANEMARU, Fuchu Tokyo (JP)

(21) Appl. No.: 14/315,014

(22) Filed: Jun. 25, 2014

(30) Foreign Application Priority Data
Jan. 29, 2014 (JP) 2014-014400

(51) Int. Cl. H04B 1/44; H04B 1/00

(52) U.S. Cl. CPC H04B 1/44; H04B 1/006

(57) ABSTRACT

According to an embodiment, a semiconductor device includes an antenna switch, a harmonic wave suppression circuit, and an impedance matching circuit. The antenna switch includes a first node, a second node to which a transmission signal in a communication band is supplied, and a third node. The harmonic wave suppression circuit is connected to the first node, and changes a frequency characteristic in response to a control signal such that a frequency component in the communication band is allowed to pass through the harmonic wave suppression circuit and a harmonic wave component of the transmission signal is suppressed. The impedance matching circuit is connected between the harmonic wave suppression circuit and an antenna, and matches an impedance of the harmonic wave suppression circuit with an impedance of the antenna in the communication band in response to the control signal.

### CROSS-REFERENCE TO RELATED APPLICATION

This application is based upon and claims the benefit of priority from Japanese Patent Application No. 2014-014400, filed Jan. 29, 2014, the entire contents of which are incorporated herein by reference.

### FIELD

Embodiments described herein relate to a semiconductor device, and a transmission and reception circuit.

### BACKGROUND

A high frequency transmission and reception circuit which is used for a mobile communication apparatus such as a smart phone or a mobile phone (hereinafter referred to as “transmission and reception circuit”) comprises: an antenna; an antenna switch; a power amplifier; a reception circuit, a transmission and reception IC and the like. The antenna switch operates to switch between transmission and reception of a cellular signal, wherein the antenna switch is controlled so as to radiate a transmission signal which is amplified to a desired power level by the power amplifier from the antenna during transmission, and is controlled so as to guide a reception signal received by the antenna to the reception circuit during reception.

Recently, in the field of mobile communication devices, cellular communication has become multi-banded along with an increase in demand for communication and the expansion of applications. At the same time, mobile communication devices include other communication systems such as wireless LAN, Bluetooth, GPS (Global Positioning System). With the additional communication systems, to satisfy a demand for miniaturization of the apparatus, the communication systems are arranged densely in an extremely narrow space and, at the same time, an antenna is shared by the additional communication systems. In this case, there exists a possibility that the plurality of communication systems influence each other. For example, when a harmonic wave of a transmission signal generated from a power amplifier or an antenna switch for cellular communication overlaps with reception signal frequency bands of other communication systems or other cellular signals, such a phenomenon interferes with stable signal reception.

In this case, a filter or a harmonic wave suppression circuit is used for every communication band.

### DESCRIPTION OF THE DRAWINGS

FIG. 1 is a block diagram illustrating the arrangement of a transmission and reception circuit according to a first embodiment.

FIG. 2 is a block diagram illustrating the specific arrangement of the transmission and reception circuit in FIG. 1.

FIG. 3 is a view for illustrating a frequency characteristic of a harmonic wave suppression circuit shown in FIG. 2.

FIG. 4 is a table illustrating a transmission frequency band, frequencies of second and third harmonic waves, and reception frequency bands of respective communication systems.

FIG. 5 is a block diagram illustrating the arrangement of a transmission and reception circuit according to a second embodiment.

FIG. 6 is a block diagram illustrating the arrangement of a transmission and reception circuit according to a third embodiment.

### DETAILED DESCRIPTION

Embodiments provide a semiconductor device and a transmission and reception circuit that suppresses harmonic waves of transmission signals in a plurality of communication bands without lowering the reception performance of the semiconductor device or the transmission and reception circuit and the communication performance of other communication systems.

In general, according to one embodiment, a semiconductor device includes: an antenna switch; a harmonic wave suppression circuit; and an impedance matching circuit. The antenna switch includes a first node, a second node to which a transmission signal in a communication band is supplied, and a third node which outputs a reception signal. The harmonic wave suppression circuit is connected to the first node and has a frequency characteristic that is alterable in response to a control signal such that a frequency component in the communication band is allowed to pass through the harmonic wave suppression circuit and a harmonic wave component of the transmission signal is suppressed. The impedance matching circuit is connected between the harmonic wave suppression circuit and an antenna and matches an impedance of the harmonic wave suppression circuit with an impedance of the antenna in the communication band in response to the control signal.

Hereinafter, exemplary embodiments are explained by reference to drawings. These embodiments do not limit the present disclosure.

### First Embodiment

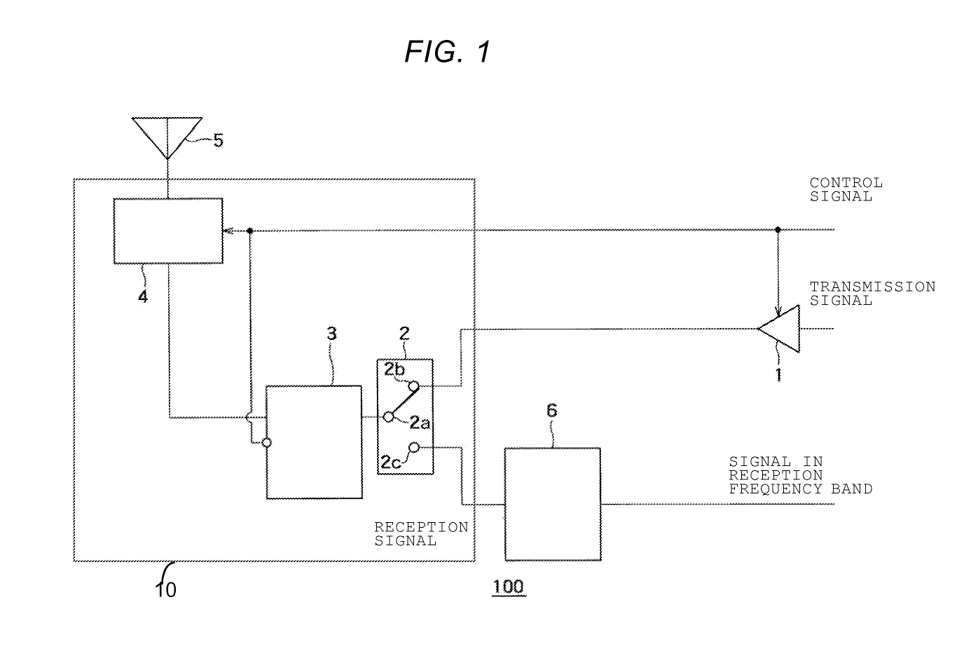

FIG. 1 is a block diagram illustrating the elements of a transmission and reception circuit 100 according to a first embodiment. As illustrated in FIG. 1, the transmission and reception circuit 100 includes: a multi-band power amplifier (amplifier) 1; an antenna switch 2; a harmonic wave suppression circuit 3; an impedance matching circuit (antenna matching circuit) 4; an antenna 5; and a reception circuit 6.

The transmission and reception circuit 100 is mounted on a mobile communication apparatus, for example, and transmits and receives signals (cellular signals) in a communication band selected from a plurality of communication bands (frequency bands). The transmission and reception signals are high-frequency signals. In this embodiment, the explanation is made assuming that the transmission and reception circuit 100 is compatible with a 3rd Generation Partnership Project (3GPP) communication system.

Although explained in detail later, each communication band includes a transmission frequency band and a reception frequency band. A harmonic wave of a transmission signal in a transmission frequency band of at least any one of the communication bands overlaps with a reception frequency band of another communication band or a reception frequency band of another communication system.

The multi-band power amplifier 1 power-amplifies a transmission signal supplied from a transmission circuit not shown in the drawing in a communication band selected from the plurality of communication bands. The multi-band power amplifier 1 changes a frequency band in which a signal is amplified in response to a control signal. The control signal indicates which communication band is selected, and is supplied from a control part not shown in the drawing, for example.

The antenna switch 2 includes : a first node 2a; a second node 2b to which transmission signals amplified by the multi-band power amplifier 1 are supplied; and a third node 2c which outputs reception signals. The antenna switch 2 may connect the first node 2a to either one of the second node 2b or the third node 2c in response to a control from the control part not shown in the drawing. That is, the antenna switch 2 adopts the SPDT (Single Pole Dual Throw) configuration. In this disclosure, “node” is a concept which includes not only a physical signal connection point such as a port and a terminal but also an arbitrary point on a signal line or a pattern having the same potential.

The harmonic wave suppression circuit 3 is connected between the first node 2a and the impedance matching circuit 4, and changes a frequency characteristic in response to a control signal such that a frequency component in a selected communication band is allowed to pass through the harmonic wave suppression circuit 3 and a harmonic wave component of the transmission signal is suppressed (reduced).

The impedance matching circuit 4 is connected between the harmonic wave suppression circuit 3 and the antenna 5, and matches an impedance of the harmonic wave suppression circuit with an impedance of the antenna 5 in the selected communication band in response to a control signal. Due to such matching, reflection loss is reduced so that the transmission and reception of a transmission and reception signal are efficiently performed.

The antenna 5 is connected to the impedance matching circuit 4. The antenna 5 radiates (transmits) transmission signals, and receives reception signals. The antenna 5 is shared with the plurality of communication bands.

The reception circuit 6 is connected to the third node 2c of the antenna switch 2, extracts a signal in a desired reception frequency band from reception signals outputted from the third node 2c using a SAW filter or a low-noise amplifier (not shown in the drawing) arranged in the inside of the reception circuit 6, and outputs the extracted signals.

Due to such an arrangement, in transmitting signals, the transmission signal amplified by the multi-band power amplifier 1 is transmitted to the antenna 5 through the antenna switch 2, the harmonic wave suppression circuit 3, and the impedance matching circuit 4.

On the other hand, in receiving signals, a reception signal received by the antenna 5 is supplied to the reception circuit 6 through the impedance matching circuit 4, the harmonic wave suppression circuit 3, and the antenna switch 2.

The antenna switch 2, the harmonic wave suppression circuit 3 and the impedance matching circuit 4 constitute a semiconductor device 10. The whole semiconductor device 10 may be formed on the same semiconductor substrate, or a part of the semiconductor device 10 may be formed on another semiconductor substrate.

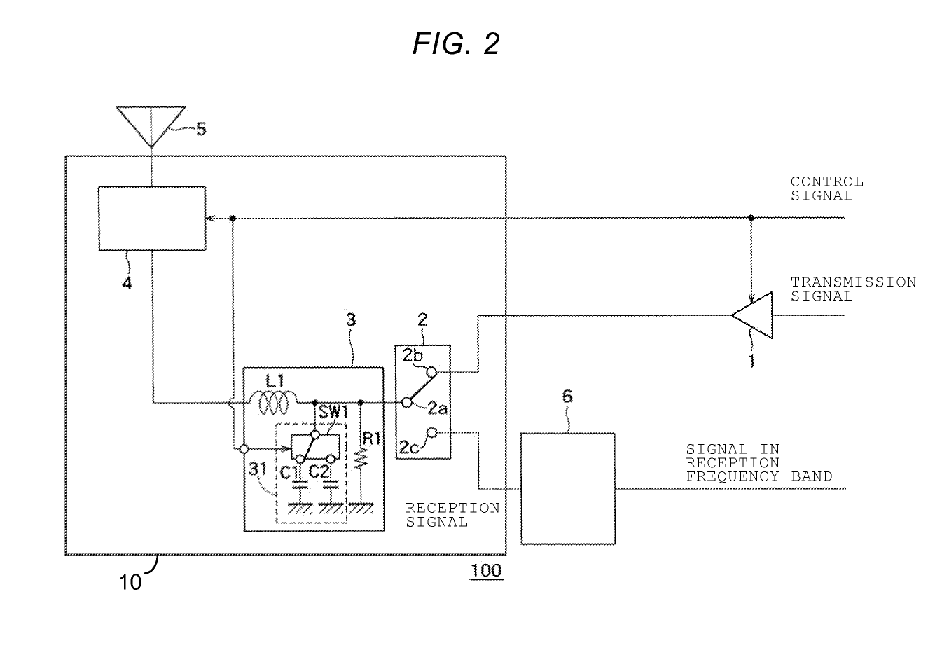

FIG. 2 is a block diagram illustrating the specific arrangement of the transmission and reception circuit 100 shown in FIG. 1. FIG. 2 also depicts the specific arrangement of the harmonic wave suppression circuit 3. Other arrangements of the transmission and reception circuit 100 are identical with the corresponding arrangements of the transmission and reception circuit 100 in FIG. 1 and hence, the same symbols are given to the identical elements, and the repeated explanation of such constitutional elements is omitted.

As illustrated in FIG. 2, the harmonic wave suppression circuit 3 includes an inductor L1, a variable capacitance circuit 31, and a resistor R1.

The inductor L1 is connected between the impedance matching circuit 4 and the first node 2a of the antenna switch 2. That is, the inductor L1 is connected in series with a transmission line through which transmission and reception signals are transmitted.

The variable capacitance circuit 31 is connected to the inductor L1, and a capacitance value of the variable capacitance circuit 31 is changed in response to a control signal. In the embodiment shown in FIG. 2, the variable capacitance circuit 31 includes a plurality of capacitors (capacitance elements) C1, C2 and an SPDT switch (switch) SW1.

The capacitor C1 has one end connected to a ground, and the other end connected to the SPDT switch SW1.

The capacitor C2 has one end connected to a ground, and the other end connected to the SPDT switch SW1. A capacitance value of the capacitor C1 is set larger than a capacitance value of the capacitor C2.

The SPDT switch SW1 connects either one of the plurality of capacitors C1, C2 to a terminal of the inductor L1 on a first-node-2a side in response to a control signal.

The resistor R1 has one end connected to a ground, and the other end connected to the terminal of the inductor L1 on the first-node-2a side.

In this manner, the harmonic wave suppression circuit 3 operates as a low-pass filter. That is, assuming an inductance of the inductor L1 as L and a capacitance value of a capacitor connected to the inductor L1 as C, a cut-off frequency fc [Hz] of the harmonic wave suppression circuit 3 is expressed by “1/(2n√/(LC))”.

A smaller inductance of the inductor L1 is desirable for reducing losses in the inductor L1.

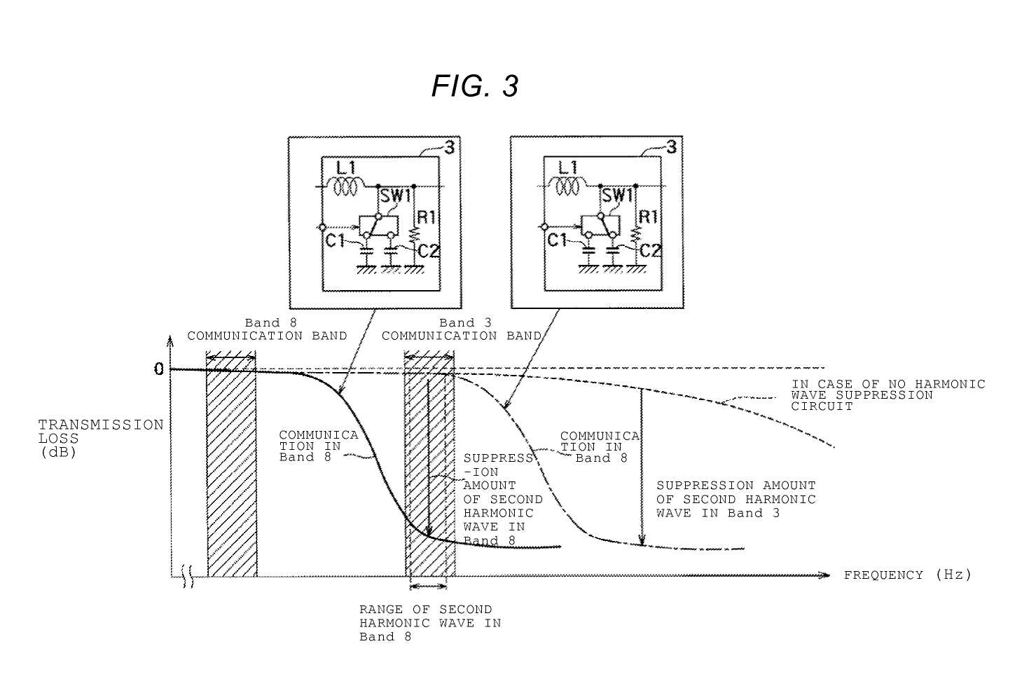

FIG. 3 is a view for illustrating a frequency characteristic of the harmonic wave suppression circuit 3 shown in FIG. 2. FIG. 3 illustrates one example of frequency characteristics in two communication bands, that is, a 3GPP Band3 and a 3GPP Band8. For a comparison purpose, FIG. 3 also shows a frequency characteristic in a state where the transmission and reception circuit 100 does not include the harmonic wave suppression circuit 3 so that the impedance matching circuit 4 is directly connected to the first node 2a of the antenna switch 2. In FIG. 3, frequency [Hz] is represented on the horizontal axis, and transmission loss [dB] is represented on the vertical axis.

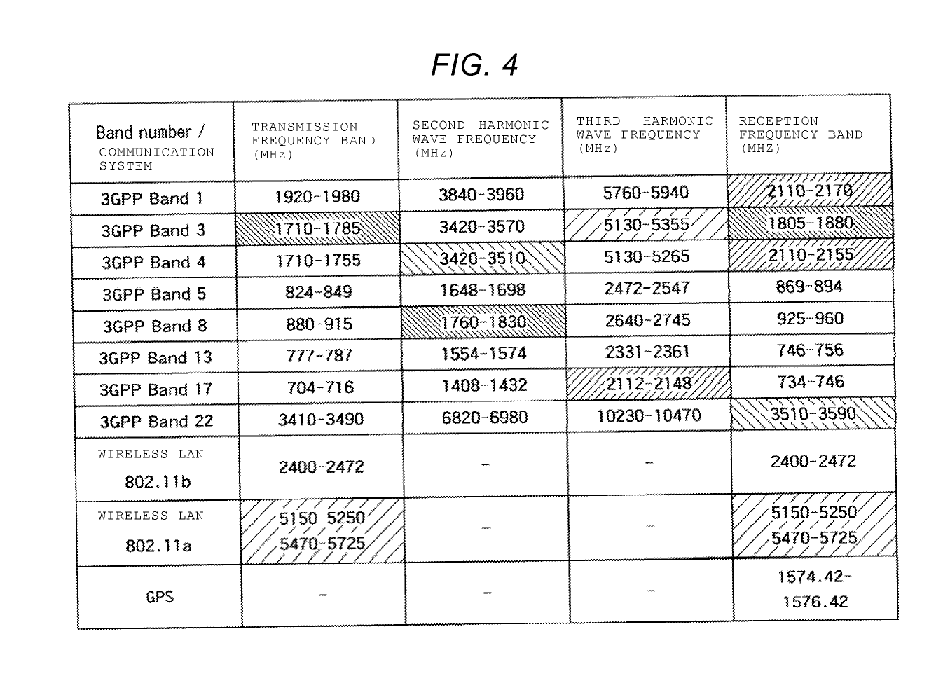

FIG. 4 is a table illustrating a transmission frequency band, frequencies of second and third harmonic waves, and a reception frequency band of each communication system. In FIG. 4, as examples of the communication systems, 3GPPs, wireless LANs and a GPS are shown. With respect to the 3GPP communication systems, a transmission frequency band and the like are indicated for respective band numbers (Bands 1, 3, 4, 5, 8, 13, 17, and 22).

As illustrated in FIGS. 3 and 4, for example, when the communication is performed in Band 8 selected from the plurality of communication bands, a second harmonic wave (1,760 to 1,830 MHz) of a transmission signal overlaps with a communication band of the Band 3 (a transmission frequency band (1,710 to 1,785 MHz) and a reception frequency band (1,805 to 1,880 MHz)).

Accordingly, in this case, the SPDT switch SW1 of the harmonic wave suppression circuit 3 is controlled in response to a control signal such that a loss becomes small in a communication band of the Band 8 (880 to 915 MHz, 925 to 960 MHz), and a loss becomes large when a transmission signal has a frequency of a second or higher-order harmonic wave. That is, the capacitor C2 having a large capacitance value is connected to the inductor L1. Due to such an arrangement, a second or higher order harmonic wave radiated from the antenna 5 at the time of transmitting signals is reduced and hence, the reception of other mobile communication devices, which perform the communication in the Band 3, is hardly influenced. In this case, the harmonic wave suppression circuit 3 exhibits a low loss in communication Band 8 and hence, the transmission and reception circuit 100 receives reception signals in communication Band 8 with a small loss.

When the communication is performed in Band 3 selected from the plurality of communication bands, for example, although a second harmonic wave or a fourth or higher order harmonic wave of a transmission signal does not overlap with respective reception frequency bands shown in FIG. 4, the second harmonic wave or the fourth or higher order harmonic wave of a transmission signal causes undesired radiation. A third harmonic wave (5,130 to 5,355 MHz) of the transmission signal overlaps with a part of a transmission and reception frequency band (5,150 to 5,250 MHz) of a wireless LAN 802.11a.

Accordingly, in this case, the SPDT switch SW1 of the harmonic wave suppression circuit 3 is controlled in response to a control signal such that a loss becomes small in the communication band of the Band 3 (1,710 to 1,785 MHz, 1,805 to 1,880 MHz), and a loss becomes large when a transmission signal has a frequency of a second or higher order harmonic wave. That is, the capacitor C1 having a small capacitance value is connected to the inductor L1 so that a cut-off frequency fc of the harmonic wave suppression circuit 3 is increased. Due to such an arrangement, a second or higher order harmonic wave radiated from the antenna 5 may be reduced and hence, the receiving performances of other mobile communication devices, which perform the communication using a wireless LAN 802.11a, are hardly influenced and, at the same time, a magnitude of undesired radiation is also reduced. In this case, the transmission and reception circuit 100 may receive reception signals in a communication band of the Band 3 with a small loss.

Also when the communication is performed in the Band 5, the Band 13 or the Band 17 illustrated in FIG. 4, in the same manner as the case where the communication is performed in the Band 8, it is sufficient to select the capacitor C1. Due to such selection, a loss becomes small in communication bands of the Band 5, the Band 13 and the Band 17, and a loss becomes large when a transmission signal has a frequency of a second or higher order harmonic wave. Accordingly, for example, when the communication is performed in the Band 17, although a third harmonic wave of the transmission signal in the Band 17 overlaps with the reception frequency band of the Band 1, the receiving performance of other mobile communication devices, which perform the communication in the Band 1, is hardly influenced.

Also when the communication is performed in the Band 1 and the Band 4 illustrated in FIG. 4, in the same manner as the case where the communication is performed in the Band 3, it is sufficient to select the capacitor C2. Due to such selection, a loss becomes small in the communication band of the Band 1 and in the communication band of the Band 4, and a loss becomes large when a transmission signal has a frequency of a second or higher order harmonic wave. Accordingly, for example, when the communication is performed in the Band 4, although a second harmonic wave of the transmission signal in the Band 4 overlaps with the reception frequency band of the Band 22, the receiving performance of other mobile communication devices, which perform the communication in the Band 22, is hardly influenced.

In the embodiment illustrated in FIG. 1 and FIG. 2, for clarification, the explanation has been made with respect to one example where the transmission and reception circuit 100 includes the antenna switch 2 having the SPDT configuration. However, the transmission and reception circuit 100 may include an antenna switch having a nPmT (n, m being a natural number of two or more) configuration which is a multi-port switch. When the transmission and reception circuit 100 includes the multi-port switch, the transmission and reception circuit 100 may include other communication systems such as a wireless LAN, Bluetooth and a GPS in addition to the 3GPP communication systems. Accordingly, the transmission and reception circuit 100 is compatible with a plurality of communication systems by switching the antenna switch 2. Due to such a configuration, the receiving performance of the communication systems other than 3GPP communication systems is hardly influenced by a harmonic wave of a 3GPP transmission signal also in the mobile communication device in addition to other mobile communication devices.

As has been explained heretofore, according to this embodiment, the transmission and reception circuit 100 includes the harmonic wave suppression circuit 3 which changes a frequency characteristic in response to a control signal such that a frequency component in the selected communication band is allowed to pass through the harmonic wave suppression circuit 3 and a harmonic wave component of a transmission signal is suppressed. Accordingly, a harmonic wave component of a transmission signal in a plurality of communication bands may be suppressed without providing a SAW filter or a harmonic wave suppression circuit for each communication band. That is, the large-sizing of the semiconductor device 10 and the increase of a circuit scale of the transmission and reception circuit 100 may be reduced and, at the same time, the increase of the number of parts may be also reduced.

Further, the harmonic wave suppression circuit 5 is provided between the impedance matching circuit 4 and the antenna switch 2 and hence, a harmonic wave component of a transmission signal generated by the antenna switch 2 may be also suppressed.

Accordingly, the lowering of the receiving performance of the mobile communication device may be prevented.

In the embodiment illustrated in FIG. 2, for clarification, the explanation has been made with respect to the example where the harmonic wave suppression circuit 3 includes the SPDT switch SW1 and two capacitors C1, C2. However, corresponding to the increase of the number of communication bands, the number of terminals of the switch may be increased and the number of capacitors maybe increased, and the frequency characteristic may be switched for respective communication bands. Due to such an arrangement, the harmonic wave suppression circuit 3 is able to set more appropriate frequency characteristics for the respective communication bands.

The configuration of the harmonic wave suppression circuit 3 is not limited to that illustrated in FIG. 2; the harmonic wave suppression circuit 3 may be formed of a filter having a more complex configuration. Additionally, the resistor R1 may not be used.

Further, the harmonic wave suppression circuit 3 may set different frequency characteristics between the time of transmitting signals and the time of receiving signals. Due to such an arrangement, it is possible to set more appropriate frequency characteristics that conform to a transmission frequency band and a reception frequency band respectively.

### Second Embodiment

A second embodiment differs from the first embodiment with respect to a variable capacitance circuit 31a of a harmonic wave suppression circuit 3a.

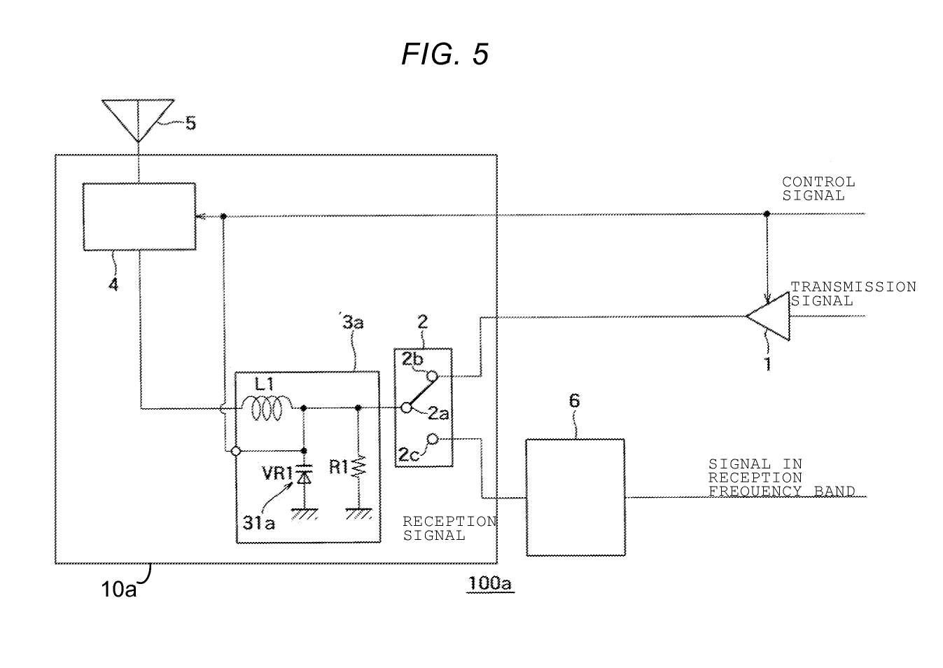

FIG. 5 is a block diagram illustrating the constitution of a transmission and reception circuit 100a according to the second embodiment. In FIG. 5, the elements identical with the corresponding elements in FIG. 2 are given the same symbols, and differences from the first embodiment are mainly explained hereinafter.

As illustrated in FIG. 5, the variable capacitance circuit 31a of the harmonic wave suppression circuit 3a includes a variable capacitance diode VR1 where a capacitance value is changed in response to a control signal. The variable capacitance diode VR1 includes a cathode connected to a terminal of an inductor L1 on a first node side, and an anode connected to a ground. Control signals are supplied to the cathode of the variable capacitance diode VR1. Accordingly, in the same manner as the first embodiment, the harmonic wave suppression circuit 3a may change a cut-off frequency in response to a control signal.

Also in this embodiment, an antenna switch 2, a harmonic wave suppression circuit 3a, and an impedance matching circuit 4 are included a semiconductor device 10a.

According to this embodiment, a cut-off frequency may be changed in response to a control signal without using a plurality of capacitors and hence, this embodiment may acquire advantageous effects substantially equal to the advantageous effects of the first embodiment with the smaller number of parts compared to the first embodiment.

### Third Embodiment

A third embodiment differs from the first embodiment with respect to a point that a transmission and reception circuit includes an additional harmonic wave suppression circuit 30.

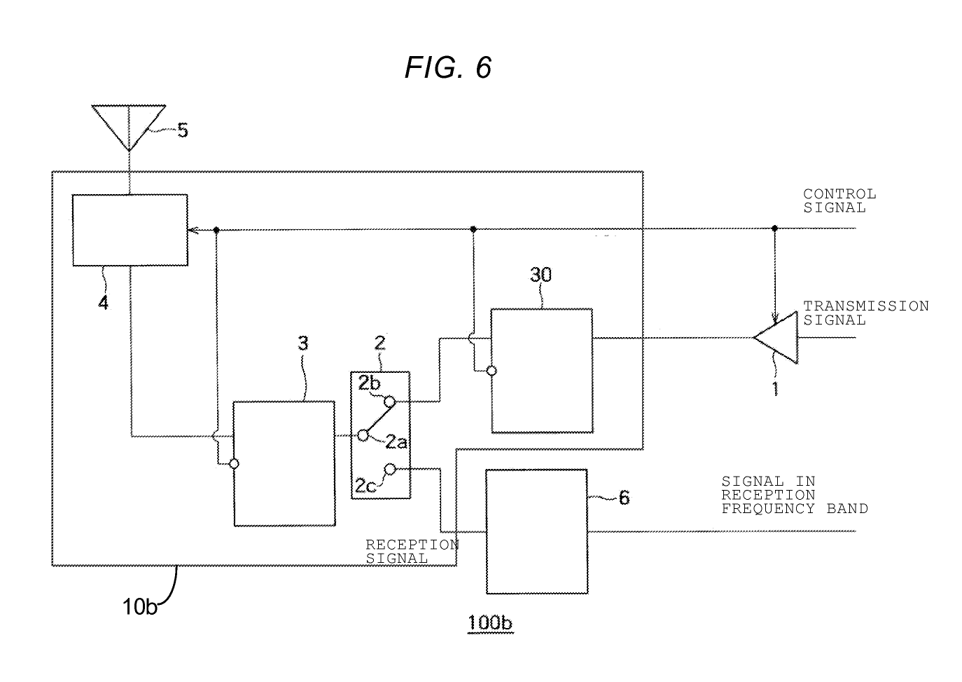

FIG. 6 is a block diagram illustrating the arrangement of a transmission and reception circuit 100b according to the third embodiment. In FIG. 6, the elements identical with the corresponding constitutional parts in FIG. 1 are given the same symbols, the difference from the first embodiment is mainly explained hereinafter.

The transmission and reception circuit 100b includes, in addition to the arrangement illustrated in FIG. 1, an additional harmonic wave suppression circuit 30. The additional harmonic wave suppression circuit 30 has the same configuration as the harmonic wave suppression circuit 3, and is connected between a second node 2b of an antenna switch 2 and a multi-band power amplifier 1. The additional harmonic wave suppression circuit 30 changes a frequency characteristic in response to a control signal such that a fundamental wave of a transmission signal amplified by a multi-band power amplifier 1 is allowed to pass through the additional harmonic wave suppression circuit 30 and is supplied to the second node 2b of the antenna switch 2 and a harmonic wave component of the transmission signal is suppressed.

The antenna switch 2, the harmonic wave suppression circuit 3, an impedance matching circuit 4, and the additional harmonic wave suppression circuit 30 constitute a semiconductor device 10b.

According to this embodiment, a harmonic wave component of a transmission signal sent from the multi-band power amplifier 1 is suppressed by the additional harmonic wave suppression circuit 30 and hence, a harmonic wave that is incident on the antenna switch 2 is reduced compared to the first embodiment. Accordingly, a suppressed amount of harmonic wave component radiated from the antenna 5 becomes the sum of the suppressed amount by the harmonic wave suppression circuit 3 and the suppressed amount by the additional harmonic wave suppression circuit 30. Accordingly, a harmonic wave radiated from the antenna 5 is further reduced compared to the first embodiment.

In the same manner as the harmonic wave suppression circuit 3, the additional harmonic wave suppression circuit 30 also changes a frequency characteristic in response to a control signal and hence, a harmonic wave component of a transmission signal in a plurality of communication bands may be suppressed.

The third embodiment may be combined with the second embodiment.

According to any one of the embodiments which has been explained heretofore, with the provision of the harmonic wave suppression circuit 3, 3a, a harmonic wave of a transmission signal in a plurality of communication bands maybe suppressed without lowering the receiving performances and the communication performances of other communication systems.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
an antenna switch including a first node, a second node to which a transmission signal in a communication band is supplied, and a third node from which a reception signal is output;
a harmonic wave suppression circuit connected to the first node, and having a frequency characteristic that is alterable in response to a control signal such that a frequency component in the communication band is allowed to pass through the harmonic wave suppression circuit and a harmonic wave component of the transmission signal is suppressed; and
an impedance matching circuit connected between the harmonic wave suppression circuit and an antenna, and configured to match an impedance of the harmonic wave suppression circuit with an impedance of the antenna in the communication band in response to the control signal.

2. The semiconductor device according to claim 1, wherein
the communication band is selected from a plurality of communication bands,
each communication band includes a transmission frequency band and a reception frequency band, and
a harmonic wave of the transmission signal in the transmission frequency band of at least any one of the communication bands overlaps with the reception frequency band of another communication band.

3. The semiconductor device according to claim 1, wherein the harmonic wave suppression circuit includes:
an inductor connected between the impedance matching circuit and the first node of the antenna switch; and
a variable capacitance circuit connected to the inductor, and having a capacitance value which changes in response to the control signal.

4. The semiconductor device according to claim 3, wherein the variable capacitance circuit includes:
a plurality of capacitance elements; and
a switch connecting any one of the plurality of capacitance elements to the inductor in response to the control signal.

5. The semiconductor device according to claim 3, wherein the variable capacitance circuit includes a variable capacitance diode whose a capacitance value changes in response to the control signal.

6. The semiconductor device according to claim 1, further comprising:
an additional harmonic wave suppression circuit having a frequency characteristic that is alterable in response to the control signal such that a fundamental wave of the transmission signal is allowed to pass through the additional harmonic wave suppression circuit and to be supplied to the second node, and a harmonic wave component of the transmission signal is suppressed.

7. The semiconductor device according to claim 1, wherein the harmonic wave suppression circuit has different frequency characteristics between during the transmission of the transmission signal and during the reception of the reception signal.

8. The semiconductor device according to claim 1, further comprising:
a reception circuit connected to the third node, wherein, when the antenna switch couples the first node to the third node, a reception signal received by the antenna is supplied to the reception circuit through the impedance matching circuit and the harmonic wave suppression circuit.

9. A transmission and reception circuit comprising:
the semiconductor device according to claim 1;
an amplifier configured to supply the transmission signal to the second node of the antenna switch;
a reception circuit configured to extract a signal in a reception frequency band from the reception signal outputted from the third node of the antenna switch; and
an antenna connected to the impedance matching circuit.

10. A method of reducing interference between a transmission band and a reception band, the method comprising:
altering a frequency characteristic of a signal to be transmitted and residing in a communication band, in response to a control signal, wherein the altered signal is such that a frequency component in the communication band is allowed to pass and a harmonic wave component of the signal is suppressed; and
providing the altered signal to an antenna via an impedance matching circuit.

11. The method according to claim 10, wherein
the communication band is selected from a plurality of communication bands,
each communication band includes a transmission frequency band and a reception frequency band, and
a harmonic wave of the transmission signal in the transmission frequency band of at least any one of the communication bands overlaps with the reception frequency band of another communication band.

12. The method according to claim 10, further comprising:
altering a frequency characteristic of an amplified signal in response to a control signal to generate an altered amplified signal, such that a fundamental wave of an amplified signal is included in the altered amplified signal but a harmonic wave component of the amplified signal is reduced;
wherein the signal to be transmitted is the altered amplified signal; and
wherein altering a frequency characteristic of the amplified signal further reduces a harmonic wave component in the altered signal provided to the antenna.

13. The method according to claim 10, further comprising
selecting between a transmission mode in which the altered signal is transmitted through the antenna and a reception mode in which a signal in a reception frequency band is received through the antenna;
wherein altering a frequency characteristic of a signal to be transmitted in response to a control signal includes altering the frequency characteristic in a first way when in the transmission mode and a second way in the reception mode.

14. A transceiver circuit comprising:
an antenna switch including a first node, a second node to which a transmission signal in transmission frequency band is supplied for transmission on an antenna when the second node is connected to the second node, and a third node from which a reception signal is output in a reception frequency band when the first node is connected to the third node, wherein a harmonic wave component of the transmission signal is in a band that overlaps with the reception frequency band; and
a harmonic wave suppression circuit connected to the first node, and having a frequency characteristic that is alterable in response to a control signal such that a frequency component in the transmission frequency band is allowed to pass through the harmonic wave suppression circuit and the harmonic wave component is suppressed.

15. The transceiver circuit according to claim 14, wherein the transmission signal is an amplified signal.

16. The transceiver circuit according to claim 14, wherein the harmonic wave suppression circuit includes:
an inductor connected between the impedance matching circuit and the first node of the antenna switch; and
a variable capacitance circuit connected to the inductor, and having a capacitance value which changes in response to the control signal.

17. The transceiver circuit according to claim 16, wherein the variable capacitance includes:
a plurality of capacitance elements; and
a switch connecting any one of the plurality of capacitance elements to the inductor in response to the control signal.

18. The transceiver circuit according to claim 16, wherein the variable capacitance includes a variable capacitance diode whose capacitance value changes in response to the control signal

19. The transceiver circuit according to claim 14, further comprising:
an impedance matching circuit connected between the harmonic wave suppression circuit and the antenna, and configured to match an impedance of the harmonic wave suppression circuit with an impedance of the antenna in the communication band in response to the control signal.

20. The transceiver circuit according to claim 19, further comprising:
an additional impedance matching circuit connected to the second node and configured to alter the frequency characteristic of an amplified transmission signal in response to a control signal such that the fundamental wave of the amplified transmission signal is allowed to pass through and a harmonic wave component of the transmission signal is suppressed.
